(19) United States
(12) Patent Application Publication
(10) Pub. No.: US 2022/0023972 A1
(43) Pub. Date: Jan. 27, 2022

(54) Laser Processing Apparatus

(71) Applicant: DISCO CORPORATION, Tokyo (JP)

(72) Inventors: Shungo YOSHII, Tokyo (JP); Junichi KUKI, Tokyo (JP); Kana AIDA, Tokyo (JP)

(21) Appl. No.: 17/380,635

(22) Filed: Jul. 20, 2021

(30) Foreign Application Priority Data
Jul. 22, 2020 (JP) 2020-125481

(51) Int. Cl. B23K 26/36; B23K 26/06; B23K 26/142

(52) U.S. Cl. CPC B23K 26/36; B23K 26/0665; B23K 2101/40; B23K 26/142; B23K 26/0648

(57) ABSTRACT

A laser processing apparatus includes a processing nozzle. The processing nozzle includes an upper wall having a laser beam passage port defined therein, a lower wall that is connected to a lower portion of a part of the upper wall and that includes a debris capturing chamber defined therein, a suction port defined between another part of the upper wall and the lower wall, a first air ejection port defined in the lower wall, for ejecting air across the debris capturing chamber toward the suction port in a predetermined direction perpendicular to an optical path of a laser beam, and a second air ejection port defined in the lower wall below the first air ejection port, for ejecting air in the predetermined direction. A flow rate of air ejected from the second air ejection port is smaller than a flow rate of air ejected from the first air ejection port.

### BACKGROUND OF THE INVENTION

### Field of the Invention

The present invention relates to a laser processing apparatus for irradiating a workpiece with a laser beam having a wavelength absorbable by the workpiece to thereby perform an ablation process on the workpiece.

### Description of the Related Art

There has been known in the art, as a method of processing a plate-shaped workpiece such as a semiconductor wafer, an ablation process for irradiating the workpiece with a laser beam having a wavelength absorbable by the workpiece while focusing the laser beam on the workpiece, thereby vaporizing part of the workpiece. According to the ablation process, for example, the focused spot of the laser beam and the workpiece are moved in a predetermined direction relatively to each other, forming a line processed groove in the workpiece. During the ablation process, swarf called debris is scattered from a processing spot in the vicinity of the focused spot. If the scattered debris is deposited on the workpiece, then the quality of the processed workpiece is lowered. In addition, if the debris is scattered above the processing spot, then, since the power of the laser beam that reaches the processing spot is reduced by the scattered debris, the period of time required to process the workpiece is extended.

In view of the above drawbacks, there has been proposed a laser processing apparatus having a processing nozzle that includes a laser beam passage port for directing a laser beam downwardly and an air ejection port for ejecting air in a direction perpendicular to a direction of travel of the laser beam. The laser processing apparatus performs an ablation process on the workpiece with the laser beam from the laser beam passage port while removing debris with the air ejected from the air ejection port (see, for example, Japanese Patent Laid-open Nos. JP2017-77568 and JP2017-35714). The processing nozzle has an opening defined in a bottom surface of a casing thereof, the opening being larger than the laser beam passage port. The processing nozzle also has a suction port for drawing in debris at a position facing the air ejection port. The opening in the bottom surface, the suction port, and the laser beam passage port surround a space functioning as a debris capturing chamber for temporarily trapping scattered debris therein.

### SUMMARY OF THE INVENTION

When air is ejected from the air ejection port, a stream of air impinges upon a lower wall of the casing of the processing nozzle and is separated into an upper air stream and a lower air stream. Debris from the ablation process tends to be deposited on a lower surface of the lower wall of the casing along the lower air stream flowing below the lower wall. The debris deposited on the lower surface of the lower wall of the casing is liable to drop off from the lower surface onto the workpiece and be deposited on the workpiece, tending to lower the quality of the processed workpiece. Therefore, the frequency of maintenance work needed for cleaning the processing nozzle, etc. becomes higher, resulting in longer downtime of the laser processing apparatus.

The present invention has been made in view of above problems. It is therefore an object of the present invention to provide a laser processing apparatus that is capable of efficiently removing debris from a processing spot and of restraining debris from being deposited on a bottom surface of a casing of a processing nozzle.

In accordance with an aspect of the present invention, there is provided a laser processing apparatus for irradiating a workpiece held on a chuck table with a laser beam having a wavelength absorbable by the workpiece to thereby perform an ablation process on the workpiece. The laser processing apparatus includes a beam condenser having a condensing lens for converging the laser beam and a processing nozzle fixed to a lower portion of the beam condenser. The processing nozzle includes an upper wall having a laser beam passage port that is defined therein and through which the laser beam converged by the condensing lens passes toward the workpiece, a lower wall that is connected to a lower portion of a part of the upper wall and that includes a debris capturing chamber defined therein, the debris capturing chamber having an upper portion connected to the laser beam passage port and an opening defined in a lower portion thereof for taking in debris scattered from the workpiece that is ablated by the laser beam, a suction port defined between another part of the upper wall and the lower wall, for drawing in the debris introduced through the opening into the debris capturing chamber, a first air ejection port defined in the lower wall, for ejecting air across the debris capturing chamber toward the suction port in a predetermined direction perpendicular to an optical path of the laser beam passing through the laser beam passage port, and a second air ejection port defined in the lower wall below the first air ejection port, for ejecting air across the debris capturing chamber toward the suction port in the predetermined direction. A flow rate of air ejected from the second air ejection port is smaller than a flow rate of air ejected from the first air ejection port.

If a flow rate of air ejected from one air ejection port is lowered in order to prevent an air stream from being separated into an upper air stream and a lower air stream, then the air stream is less liable to act on the debris in the debris capturing chamber, tending to reduce capability to discharge the debris into the suction port. On the other hand, if the air ejection port is positionally shifted upwardly without lowering the flow rate in order to prevent the air stream from being separated into an upper air stream and a lower air stream, then, since the air stream is not separated, the debris is unlikely to be deposited on a lower surface of the lower wall. However, the air is less liable to act on the debris in a region near a processing spot in the debris capturing chamber. In this case, therefore, the capability to discharge the debris into the suction port is also lowered when the workpiece is processed by the laser beam. According to the aspect of the present invention, the processing nozzle has the first ejection port and the second ejection port positioned below the first ejection port, and the flow rate of air ejected from the second air ejection port is smaller than the flow rate of air ejected from the first air ejection port. These features are effective to prevent the debris from being deposited on the lower surface of the lower wall and also to prevent the capability to discharge the debris into the suction port from being lowered. In other words, both the deposition of the debris and the reduction in the capability to discharge the debris are prevented from occurring.

The above and other objects, features and advantages of the present invention and the manner of realizing them will become more apparent, and the invention itself will best be understood from a study of the following description and appended claim with reference to the attached drawings showing a preferred embodiment of the invention.

### BRIEF DESCRIPTION OF THE DRAWINGS

FIG. 1 is a perspective view of a laser processing apparatus according to an embodiment of the present invention;

FIG. 2 is a perspective view of a beam condenser, etc. as viewed from the side of a bottom surface of the beam condenser; and

FIG. 3 is a side elevational view, partly in cross section, of the beam condenser, etc.

### DETAILED DESCRIPTION OF THE PREFERRED EMBODIMENT

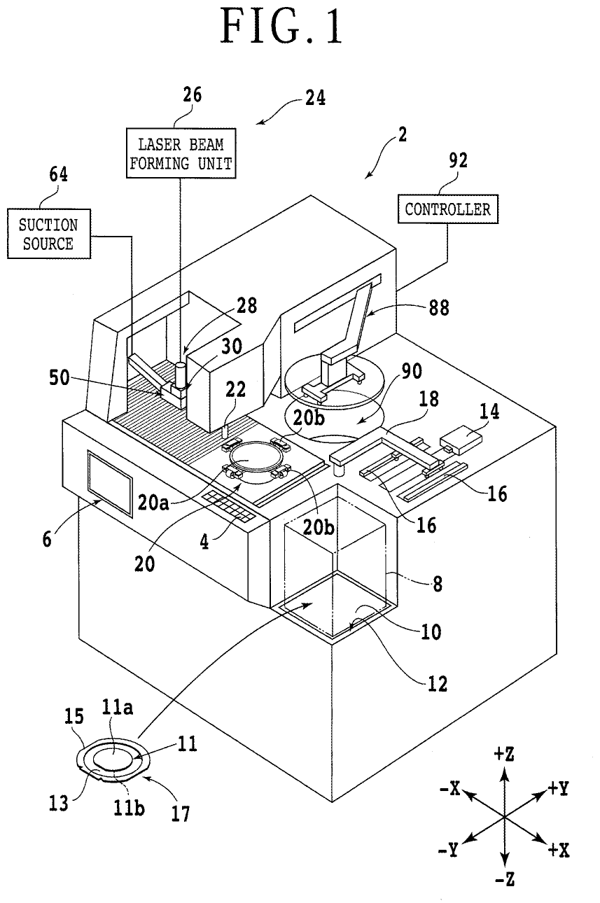

A laser processing apparatus according to a preferred embodiment of the present invention will be described below with reference to the accompanying drawings. FIG. 1 illustrates in perspective the laser processing apparatus, denoted by 2, according to the present embodiment. In FIG. 1, some components of the laser processing apparatus 2 are illustrated in functional block form. X-axis directions, i.e., processing feed directions or horizontal or leftward and rightward directions, Y-axis directions, i.e., indexing feed directions or horizontal or forward and rearward directions, and Z-axis directions, i.e., heightwise directions or vertical directions, established with respect to the laser processing apparatus 2 are oriented perpendicularly to each other. The X-axis directions include a +X direction and a −X direction that are opposite each other, the Y-axis directions include a +Y direction and a −Y direction that are opposite each other, and the Z-axis directions include a +Z direction and a −Z direction that are opposite each other. The laser processing apparatus 2 includes a control panel 4 mounted on an upper surface of a front end portion thereof. An operator of the laser processing apparatus 2 can set processing conditions in the laser processing apparatus 2 by entering predetermined input signals through the control panel 4. The laser processing apparatus 2 also includes a display device 6 such as a liquid crystal display panel on a side surface of the front end portion thereof.

When the laser processing apparatus 2 is in operation, it performs an ablation process on a workpiece 11. The workpiece 11 includes a semiconductor wafer made of silicon or the like, for example. The workpiece 11 has a grid of projected dicing lines that is not illustrated but established on a face side 11a thereof that is illustrated as facing upwardly. The workpiece 11 also has a plurality of devices, not illustrated, such as integrated circuits (ICs) or large-scale-integration (LSI) circuits formed in respective areas demarcated on the face side 11a by the projected dicing lines. The workpiece 11 has a reverse side 11b that is illustrated as facing downwardly. A circular dicing tape, i.e., an adhesive tape, 13 made of resin is affixed to the reverse side 11b of the workpiece 11.

The dicing tape 13 has a diameter larger than a diameter of the workpiece 11. The workpiece 11 is affixed to a central portion of the dicing tape 13. The dicing tape 13 has an outer circumferential portion to which a surface of an annular frame 15 made of metal is affixed. The workpiece 11, the dicing tape 13, and the frame 15 jointly make up a frame unit 17. A plurality of frame units 17 are stored in a cassette 8 that is placed on a rectangular cassette table 10 disposed in a front corner of the laser processing apparatus 2.

A cassette elevator 12 for vertically moving the cassette table 10 is coupled to a lower end of the cassette table 10. A push-pull arm 14 for delivering a frame unit 17 is disposed behind the cassette table 10. The push-pull arm 14 unloads a workpiece 11 to be processed from the cassette 8 while gripping and pulling the frame 15 of the frame unit 17 including the workpiece 11. The push-pull arm 14 also loads a processed workpiece 11 into the cassette 8 by pushing the frame 15 of the frame unit 17 including the workpiece 11.

A pair of positioning members, i.e., guide rails, 16 are disposed one on each side of a path along which the push-pull arm 14 is movable. The positioning members 16 adjust a position in the X-axis directions of a frame unit 17. A first delivery unit 18 for delivering a frame unit 17 is disposed near the positioning members 16. The first delivery unit 18 has an arm, a suction pad disposed on an end of the arm, and a turning mechanism on another end of the arm.

The first delivery unit 18 operates as follows: While the suction pad is attracting the frame 15 of a frame unit 17 under suction, the turning mechanism turns the arm through a predetermined angle to deliver the frame unit 17 from the positioning members 16 to a disk-shaped chuck table 20. The chuck table 20 is disposed adjacent to the cassette table 10 and the cassette elevator 12 in the X-axis directions. The chuck table 20 has a disk-shaped frame made of metal.

The frame of the chuck table 20 has an upwardly open disk-shaped recess that is not illustrated but defined in an upper surface thereof, and a disk-shaped porous plate is fitted in the recess. The porous plate has a lower surface connected to an end of a fluid channel that is not illustrated but defined in the frame. The fluid channel has another end connected to a suction source, not illustrated, such as an ejector. When the suction source is actuated, it generates a negative pressure that is transmitted through the fluid channel to the porous plate where the negative pressure acts through the porous plate on an upper surface thereof. The upper surface of the frame and the upper surface of the porous plate function as a substantially flat uniform holding surface 20a.

The workpiece 11 of a frame unit 17 is placed on the holding surface 20a with the face side 11a thereof being exposed upwardly. The reverse side 11b of the workpiece 11 is held under suction on the holding surface 20a with the dicing tape 13 being interposed therebetween. At this time, the frame 15 is gripped by a plurality of clamps 20b disposed at angularly spaced intervals on an outer circumferential portion of the chuck table 20. The chuck table 20 is disposed above a rotary actuator, not illustrated, such as an electric motor coupled to the chuck table 20 for rotating the chuck table 20 about a rotational axis extending vertically parallel to the Z-axis directions. A processing feed unit, not illustrated, is coupled to a lower portion of the rotary actuator for moving the chuck table 20 and the rotary actuator in the X-axis directions.

The processing feed unit has an X-axis movable table, not illustrated, that supports the rotary actuator thereon. The X-axis movable table is slidably mounted on a pair of X-axis guide rails that are not illustrated but extend parallel to the X-axis directions. A ball screw, not illustrated, is disposed between the X-axis guide rails and extends in the X-axis directions. The ball screw has an end coupled to an actuator, not illustrated, such as a stepping motor for rotating the ball screw about its central axis.

The ball screw is operatively threaded through a nut that is not illustrated but mounted on a lower surface of the X-axis movable table. When the actuator such as a stepping motor is energized, it rotates the ball screw about its central axis, causing the nut and the X-axis movable table to move the chuck table 20 together with the rotary actuator in the X-axis directions. An image capturing unit 22 that faces the holding surface 20a of the chuck table 20 is disposed above a path along which the chuck table 20 is movable in the X-axis directions. The image capturing unit 22 has an optical system including an objective lens, an image sensor, etc., and captures an image of the face side 11a of the workpiece 11 held on the holding surface 20a, for example.

The image captured by the image capturing unit 22 is displayed on the display device 6, for example. A laser beam applying unit 24 is disposed on one side of the image capturing unit 22 along the X-axis directions. The laser beam applying unit 24 has a laser beam forming unit 26. The laser beam forming unit 26 has a laser oscillator, not illustrated, for oscillating a laser beam. The laser oscillator includes a rod-shaped laser medium of Nd:YAG or ND:YVO₄, for example. The laser oscillator emits a laser beam as a pulsed output laser beam from the laser beam forming unit 26.

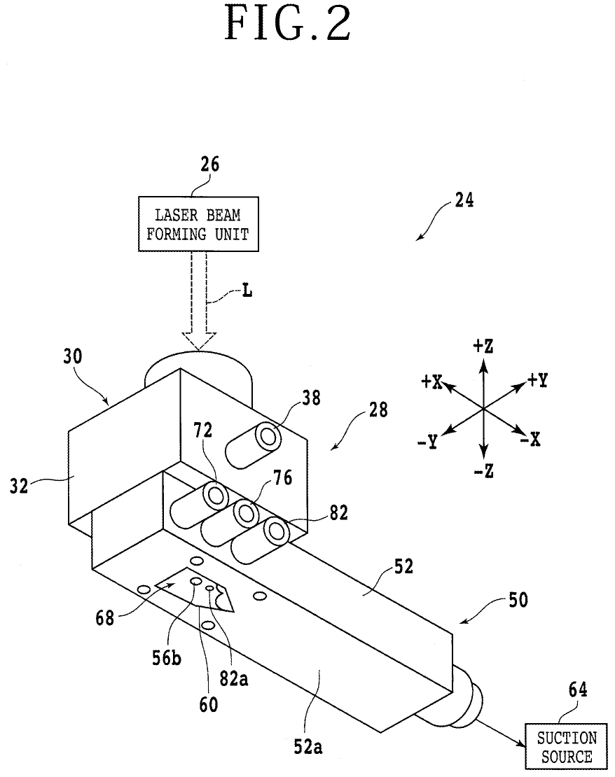

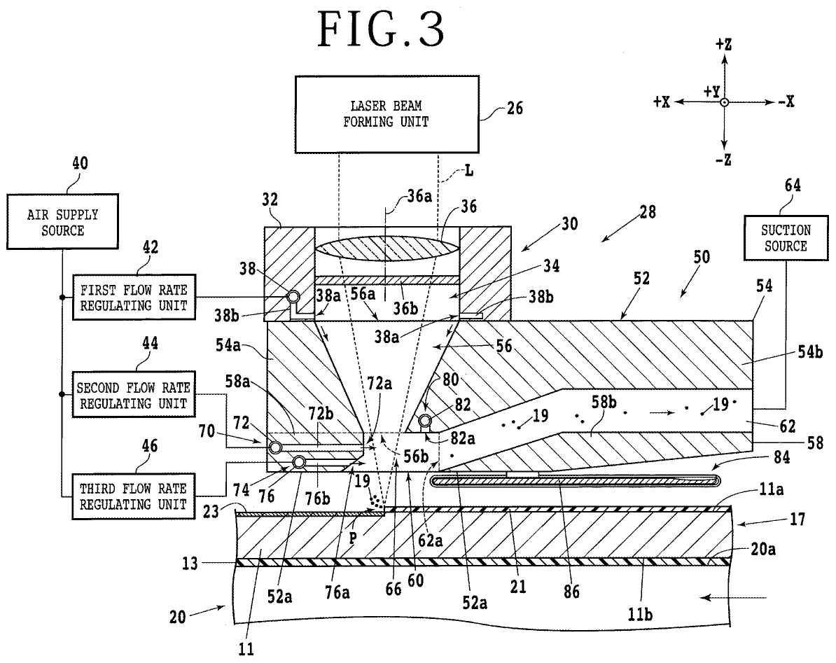

The laser beam forming unit 26 also has an output regulator, not illustrated, for regulating the level of the output laser beam. The output regulator includes an attenuator, for example. The laser beam forming unit 26 regulates the laser beam emitted from the laser oscillator to an average output level of 6.0 W, for example. The laser beam, denoted by L in FIGS. 2 and 3, emitted from the laser oscillator is a pulsed laser beam having a wavelength of 355 nm, for example, absorbable by the workpiece 11, and is applied to a beam condenser 30 of a processing head 28.

Structural details of the beam condenser 30, etc. will be described below with reference to FIGS. 2 and 3. FIG. 2 illustrates in perspective the beam condenser 30, etc. as viewed from the side of a bottom surface 52a of the beam condenser 30, and FIG. 3 illustrates the beam condenser 30, etc. in side elevation, partly in cross section. The beam condenser 30 has a casing 32 in the shape of a rectangular parallelepiped. As illustrated in FIG. 3, the casing 32 has a substantially cylindrical through hole 34 defined therein that extends vertically therethrough. A condensing lens 36 for converging the laser beam L is fixedly disposed in an upper portion of the through hole 34. The condensing lens 36 has an optical axis 36a extending substantially parallel to the Z-axis directions.

A disk-shaped glass cover 36b is fixedly disposed in the through hole 34 at a position between the condensing lens 36 and a lower end of the through hole 34. The laser beam L can pass through the glass cover 36b. A tube 38 that extends in the Y-axis directions is fixed to a lower portion of the casing 32. The tube 38 is supplied with air from an air supply source 40 through a first flow rate regulating unit 42. The air supply source 40 includes a compressor for delivering compressed air, a tank for storing compressed air from the compressor, etc.

The first flow rate regulating unit 42 has a flow rate regulating valve, not illustrated, for regulating the flow rate of air to be supplied to the tube 38. The casing 32 has an annular groove 38a defined circumferentially at a predetermined vertical position in an inner circumferential side surface of the casing 32 that defines the through hole 34. The casing 32 also has a fluid channel 38b defined therein that has an end connected to the annular groove 38a and another end connected to the tube 38. The annular groove 38a is thus supplied with air from the first flow rate regulating unit 42 through the tube 38 and the fluid channel 38b. The annular groove 38a ejects the supplied air at a rate of 10 L/min., for example, and the ejected air flows as a downward air stream. The air stream flows out of another casing 52, described later, joined to the casing 32 through a lower opening 56b defined in the casing 52. The air stream thus flowing from the annular groove 38a is effective to suppress foreign matter such as debris 19 from being deposited on the glass cover 36b.

A processing nozzle 50 is fixed to a lower portion of the beam condenser 30. The processing nozzle 50 has the casing 52 substantially shaped as a rectangular parallelepiped that is longer in the X-axis directions than the casing 32. The casing 52 includes an upper wall 54 positioned in an upper portion thereof. The upper wall 54 has a cavity 56 defined therein that is of an inverted frustoconical shape. With reference to FIG. 3, a portion of the upper wall 54 that is positioned on the +X direction side of the cavity 56 is referred to as a +X-direction-side upper wall 54a, and another portion of the upper wall 54 that is positioned on the −X direction side of the cavity 56 is referred to as a −X-direction-side upper wall 54b.

The cavity 56 has its heightwise directions substantially parallel to the Z-axis directions. The casing 52 is positionally adjusted such that the cavity 56 is concentric with the through hole 34 and has an upper opening 56a connected contiguously to the lower end of the through hole 34. The lower opening 56b, which is of a circular shape smaller in diameter than the upper opening 56a, is positioned at a lower end of the cavity 56. The lower opening 56b functions as a laser beam passage port through which the laser beam L converged by the condensing lens 36 passes. The laser beam L is applied from the lower opening 56b to the workpiece 11 that is positioned below the processing nozzle 50.

The casing 52 includes a lower wall 58 positioned in a lower portion thereof. The lower wall 58 includes a +X-direction-side lower wall 58a connected to the +X-direction-side upper wall 54a on the +X direction side of the lower opening 56b. The boundary between the +X-direction-side upper wall 54a and the +X-direction-side lower wall 58a is indicated by a broken line for illustrative purposes in FIG. 3, though, in practice, they are integrally formed with each other. The lower wall 58 also includes a −X-direction-side lower wall 58b disposed opposite the +X-direction-side lower wall 58a across the lower opening 56b and disposed below the −X-direction-side upper wall 54b in facing relation thereto. The lower wall 58 has an opening 60 defined in a lower portion thereof for taking in the debris 19 that is scattered from the workpiece 11 when the workpiece 11 is processed in an ablation process.

The opening 60 is of a substantially pentagonal shape as viewed from the side of the bottom surface 52a of the casing 52 illustrated in FIG. 2. The casing 52 has a suction channel 62 for drawing in the debris 19, etc., defined therein between the −X-direction-side upper wall 54b and the −X-direction-side lower wall 58b. The suction channel 62 has a suction port 62a defined at an end thereof in the +X direction. The suction channel 62 has another end in the −X direction that is connected to a suction source 64 such as an ejector. The suction source 64 develops a predetermined gage pressure in a range from −10 kPa to −1 kPa, for example, in the suction channel 62 for drawing in the debris 19, etc. from the suction port 62a.

The lower opening 56b, the opening 60, a side surface of the +X-direction-side lower wall 58a in the −X direction, and the suction port 62a surround a space functioning as a debris capturing chamber 66. The debris 19 that is scattered from the workpiece 11 when the workpiece 11 is processed in an ablation process is taken into the debris capturing chamber 66 through the opening 60 and thereafter drawn into the suction channel 62 through the suction port 62a. The debris capturing chamber 66 has an upper portion connected to the lower opening 56b and has a portion functioning to pass therethrough the laser beam L emitted from the lower opening 56b toward the workpiece 11.

The +X-direction-side lower wall 58a includes a first air ejector 70 having a tube 72 extending in the Y-axis directions and connected to the casing 52. The tube 72 is supplied with air from the air supply source 40 through a second flow rate regulating unit 44. The second flow rate regulating unit 44 has a flow rate regulating valve, not illustrated, for regulating the flow rate of air to be supplied to the tube 72. The +X-direction-side lower wall 58a has a first air ejection port 72a defined in the side surface thereof that faces the debris capturing chamber 66, i.e., the surface that faces in the −X direction.

The first air ejection port 72a is supplied with air from the tube 72 through a fluid channel 72b defined in the +X-direction-side lower wall 58a along the X-axis directions. The first air ejection port 72a is of an oblong shape that is wider in the Y-axis directions as viewed along the X-axis directions. For example, the first air ejection port 72a has a width of approximately 2.5 mm in the Y-axis directions and a width of 1.0 mm in the Z-axis directions. The first air ejection port 72a ejects air across the debris capturing chamber 66 toward the suction port 62a in the −X-axis direction, i.e., a predetermined direction, perpendicular to the optical path of the laser beam L passing through the lower opening 56b. The first air ejection port 72a that is wide in the Y-axis directions ejects air, thereby reducing the amount of debris 19 deposited on the glass cover 36b more reliably than if the first air ejection port 72a were of a smaller width in the Y-axis directions.

The +X-direction-side lower wall 58a also includes a second air ejector 74 disposed below the first air ejector 70. The second air ejector 74 has a tube 76 extending in the Y-axis directions and connected to the casing 52. The tube 76 is supplied with air from the air supply source 40 through a third flow rate regulating unit 46. The third flow rate regulating unit 46 has a flow rate regulating valve, not illustrated, for regulating the flow rate of air to be supplied to the tube 76. The +X-direction-side lower wall 58a has a second air ejection port 76a defined in the side surface thereof that faces the debris capturing chamber 66 in the −X direction below the first air ejection port 72a.

The second air ejection port 76a is supplied with air from the tube 76 through a fluid channel 76b defined in the +X-direction-side lower wall 58a along the X-axis directions. The second air ejection port 76a is of a circular shape as viewed along the X-axis directions. For example, the second air ejection port 76a has a diameter of approximately 1.5 mm. However, the second air ejection port 76a may alternatively be of an oblong shape as is the case with the first air ejection port 72a. The second air ejection port 76a has its center spaced a predetermined distance downwardly from a center of the first air ejection port 72a. For example, a first distance from the center of the first air ejection port 72a to the opening 60 is adjusted to a predetermined value ranging from 1.05 to 3.34 times a second distance from the center of the second air ejection port 76a to the opening 60, i.e., 1.05≤first distance/second distance ≤3.34.

As is the case with the first air ejection port 77a, the second air ejection port 76a ejects air across the debris capturing chamber 66 toward the suction port 62a in the −X-axis direction, i.e., a predetermined direction. According to the present embodiment, the flow rate of air ejected from the second air ejection port 76a is smaller than the flow rate of air ejected from the first air ejection port 72a. The flow rate of air ejected from the second air ejection port 76a is adjusted to ½ or lower, ⅓ or lower, ¼ or lower, etc. of the flow rate of air ejected from the first air ejection port 72a. For example, the first air ejection port 72a ejects air at a predetermined flow rate ranging from 70 L/min. to 100 L/min., whereas the second air ejection port 76a ejects air at a predetermined flow rate ranging from 20 L/min. to 30 L/min.

The debris 19 taken into the debris capturing chamber 66 is assisted by the air ejected from the first air ejection port 72a and the second air ejection port 76a in being drawn into the suction port 62a and thereafter discharged from the processing head 28. In this manner, the debris capturing chamber 66, the suction port 67a, the first air ejection port 77a, the second air ejection port 76a, etc. function as a debris removing unit for drawing in and removing the debris 19.

A comparative example in which the +X-direction-side lower wall 58a has only one air ejection port will be considered below. When air is ejected from the air ejection port at a predetermined flow rate in order to reliably expel the debris 19 introduced into the debris capturing chamber 66 toward the suction port 67a, the air stream may possibly impinge upon the −X-direction-side lower wall 58b. When the air stream impinges upon the −X-direction-side lower wall 58b, the air stream is separated into an upper air stream and a lower air stream. The debris 19 tends to be deposited on the bottom surface 52a of the −X-direction-side lower wall 58b, e.g., a shutter 86 to be described later, along the lower air stream flowing below the lower wall 58.

If the flow rate of air from the air ejection port is lowered from a predetermined flow rate in order to prevent the debris 19 from being deposited on the bottom surface 52a of the −X-direction-side lower wall 58b, then the air stream is less liable to act on the debris 19 in the debris capturing chamber 66, tending to reduce the capability to discharge the debris 19 into the suction port 62a. On the other hand, if the air ejection port is positionally shifted upwardly in order to prevent the air stream from being separated into an upper air stream and a lower air stream, then, since the air ejected from the air ejection port at a predetermined flow rate is not separated, the debris 19 is unlikely to be deposited on the bottom surface 52a of the −X-direction-side lower wall 58b. However, the air is less liable to act on the debris 19 in a region near a processing spot P in the debris capturing chamber 66. In this case, therefore, the capability to discharge the debris 19 into the suction port 62a is also lowered when the workpiece 11 is processed by the laser beam L.

According to the present embodiment, the first air ejection port 72a and the second air ejection port 76a positioned below the first air ejection port 72a are incorporated in the processing nozzle 50, and the flow rate of air ejected from the second air ejection port 76a is smaller than the flow rate of air ejected from the first air ejection port 72a. These features of the present embodiment are effective to prevent the debris 19 from being deposited on the bottom surface 52a of the −X-direction-side lower wall 58b and also to prevent the capability to discharge the debris 19 into the suction port 62a from being lowered. In other words, both the deposition of the debris 19 and the reduction in the capability to discharge the debris 19 are prevented from occurring. Consequently, the debris 19 is efficiently removed from the processing spot P, and the debris 19 is prevented from being deposited on the bottom surface 52a of the −X-direction-side lower wall 58b.

A cleaner 80 is disposed in a bottom portion of the −X-direction-side upper wall 54b near the suction port 62a. The cleaner 80 has a tube 82 extending along the Y-axis directions and connected to the casing 52. The tube 82 is supplied with a cleaning fluid such as pure water through a fourth flow rate regulating unit, not illustrated. The fourth flow rate regulating unit has a flow rate regulating valve for regulating the flow rate of the cleaning fluid to be supplied to the tube 82. The −X-direction-side upper wall 54b has a cleaning fluid supply port 82a that is defined in a bottom surface thereof and that is connected to the tube 82. The cleaning fluid supplied from the cleaning fluid supply port 82a is used to clean the debris capturing chamber 66 after the workpiece 11 has been processed by the laser beam L.

The bottom surface 52a of the lower wall 58 is associated with a shutter mechanism 84 for selectively opening and closing the opening 60. In FIG. 2, the shutter mechanism 84 is omitted from illustration for illustrative purposes. The shutter mechanism 84 includes the shutter 86 having an area large enough to cover the opening 60. The shutter 86 is movable in the X-axis directions by a shutter moving device, not illustrated. When the workpiece 11 is to be processed by the laser beam L, the shutter moving device moves the shutter 86 in the −X direction to open the opening 60. After the workpiece 11 has been processed by the laser beam L, the shutter moving device moves the shutter 86 in the +X direction to close the opening 60.

Other components of the laser processing apparatus 2 will be described below with reference to FIG. 1. A Y-axis and Z-axis moving mechanism, not illustrated, is coupled to the laser beam applying unit 24 for moving the laser beam applying unit 24 in the Y-axis directions and the Z-axis directions. In a case where the chuck table 20 is movable in both the X-axis directions and the Y-axis directions in the laser processing apparatus 2, a Z-axis moving mechanism, not illustrated, may alternatively be coupled to the laser beam applying unit 24 for moving the laser beam applying unit 24 in the Z-axis directions.

A second delivery unit 88 for delivering a frame unit 17 is disposed behind the chuck table 20 in the +Y direction. The second delivery unit 88 is disposed above a coating cleaning unit 90. The coating cleaning unit 90 has a spinner table, not illustrated, for holding a frame unit 17 under suction, a cleaning nozzle that is not illustrated but disposed above the spinner table, for ejecting a cleaning fluid such as pure water toward a holding surface of the spinner table, and a resin coating nozzle that is not illustrated but disposed in a position different from the cleaning nozzle above the spinner table, for ejecting a water-soluble resin toward the holding surface of the spinner table. The water-soluble resin includes polyvinyl alcohol, ethylene glycol, or the like.

After the face side 11a of a workpiece 11 on the spinner table has been coated with the water-soluble resin, it is dried to form a water-soluble protective film 21 (see FIG. 3) on the face side 11a. The protective film 21 prevents debris 19 from being directly deposited on the face side 11a while the workpiece 11 is being processed with the laser beam L. After a workpiece 11 has been processed with the laser beam L, the workpiece 11 is put on the spinner table and the spinner table is rotated while the cleaning fluid is being ejected from the cleaning nozzle to the face side 11a, removing the protective film 21 from the face side 11a. The protective film 21 and any debris 19 can thus be removed together from the face side 11a.

The cassette elevator 12, the push-pull arm 14, the positioning members 16, the first delivery unit 18, the chuck table 20, the image capturing unit 22, the laser beam applying unit 24, the second delivery unit 88, the coating cleaning unit 90, etc. are controlled in operation by a controller 92. The controller 92 is implemented, for example, by a computer including a processor, i.e., a processing device, typified by a central processing unit (CPU), a main storage device such as a dynamic random access memory (DRAM), a static random access memory (SRAM), or a read only memory (ROM), and an auxiliary storage device such as a flash memory, a hard disk drive, or a solid state drive. The auxiliary storage device stores software represented by predetermined programs. The controller 92 has functions performed when the processing device, etc. is operated according to the software stored in the auxiliary storage device. The controller 92 automatically performs a laser processing process on workpieces 11.

Next, a procedure of the laser processing process will be described below. First, the push-pull arm 14 unloads a frame unit 17 from the cassette 8, and then the first delivery unit 18 delivers the frame unit 17 from the push-pull arm 14 to the coating cleaning unit 90. The coating cleaning unit 90 forms a protective film 21 on the face side 11a of the workpiece 11 of the frame unit 17 (protective film forming step S10). After the protective film forming step S10, the first delivery unit 18 delivers the frame unit 17 from the coating cleaning unit 90 to the chuck table 20.

The holding surface 20a of the chuck table 20 holds the reverse side 11b of the workpiece 11 under suction thereon, and then the projected dicing lines that lie parallel to each other along a direction are positioned substantially parallel to the X-axis directions with use of the image capturing unit 22, etc. An area directly below the lower opening 56b is positioned on an extension of one of the projected dicing lines. While a focused spot of the laser beam L is being positioned near the face side 11a of the workpiece 11, the laser beam L is applied to the face side 11a, and at the same time the chuck table 20 and the processing head 28 are processing-fed relatively to each other along the X-axis directions. The applied laser beam L performs an ablation process on the face side 11a of the workpiece 11 along a path of movement of the focused spot of the laser beam L, forming a laser-processed groove 23 in the workpiece 11 (see FIG. 3).

After the ablation process has been performed on the workpiece 11 along all the projected dicing lines that lie parallel to each other along the direction, the chuck table 20 is turned 90 degrees. Then, the laser beam L is applied to the workpiece 11 to perform an ablation process thereon along all of the projected dicing lines that lie parallel to each other along another direction perpendicular to the direction referred to above (laser processing step S20). Generally, when the ablation process is performed on the workpiece 11 and the protective film 21, debris 19 is more liable to be deposited on the bottom surface 52a of the −X-direction-side lower wall 58b than when the ablation process is performed only on the workpiece 11 with no protective film 21 formed thereon.

According to the present embodiment, as described above, the debris 19 is prevented from being deposited on the bottom surface 57a, and the reduction in the capability to discharge the debris 19 are prevented from occurring. Therefore, even in a case where an ablation process is performed on the workpiece 11 with the protective film 21 formed thereon, deposition of the debris 19 on the bottom surface 52a is reduced. Consequently, the debris 19 is efficiently removed from the processing spot P, and at the same time the debris 19 is restrained from being deposited on the bottom surface 52a.

After the laser processing step S20, the second delivery unit 88 delivers the frame unit 17 from the chuck table 20 to the coating cleaning unit 90 where the holding surface of the spinner table holds the reverse side 11b of the workpiece 11 thereon. In the coating cleaning unit 90, while the spinner table is in rotation, the cleaning nozzle ejects the cleaning fluid to the face side 11a of the workpiece 11, thereby cleaning away any debris 19 and the protective film 21. Thereafter, the cleaning nozzle stops ejecting the cleaning fluid, and then the spinner table is rotated again to dry the workpiece 11 (cleaning and drying step S30). After the cleaning and drying step S30, the first delivery unit 18, the push-pull arm 14, etc. load the frame unit 17 back into the cassette 8.

Changes and modifications may be made in the structural details, the method details, etc. according to the above embodiment without departing from the scope of the object of the present invention.

The present invention is not limited to the details of the above described preferred embodiment. The scope of the invention is defined by the appended claim and all changes and modifications as fall within the equivalence of the scope of the claim are therefore to be embraced by the invention.

What is claimed is:

1. A laser processing apparatus for irradiating a workpiece held on a chuck table with a laser beam having a wavelength absorbable by the workpiece to thereby perform an ablation process on the workpiece, comprising:
a beam condenser having a condensing lens for converging the laser beam; and
a processing nozzle fixed to a lower portion of the beam condenser,
wherein the processing nozzle includes
an upper wall having a laser beam passage port that is defined therein and through which the laser beam converged by the condensing lens passes toward the workpiece,
a lower wall that is connected to a lower portion of a part of the upper wall and that includes a debris capturing chamber defined therein, the debris capturing chamber having an upper portion connected to the laser beam passage port and an opening defined in a lower portion thereof for taking in debris scattered from the workpiece that is ablated by the laser beam,
a suction port defined between another part of the upper wall and the lower wall, for drawing in the debris introduced through the opening into the debris capturing chamber,
a first air ejection port defined in the lower wall, for ejecting air across the debris capturing chamber toward the suction port in a predetermined direction perpendicular to an optical path of the laser beam passing through the laser beam passage port, and
a second air ejection port defined in the lower wall below the first air ejection port, for ejecting air across the debris capturing chamber toward the suction port in the predetermined direction, and a flow rate of air ejected from the second air ejection port is smaller than a flow rate of air ejected from the first air ejection port.
